(19) United States
(12) Patent Application Publication
(10) Pub. No.: US 2011/0274201 A1
(43) Pub. Date: Nov. 10, 2011

(54) DEVICE, METHOD AND SYSTEM OF WIRELESS COMMUNICATION OVER AN EXTREMELY HIGH RADIOFREQUENCY BAND

(76) Inventors: Shay Freundlich, Sunnyvale, CA (US); Daniel Stopler, Holon (IL); Meir Feder, Herzliya (IL)

(21) Appl. No.: 12/998,379

(22) PCT Filed: Oct. 28, 2009
(86) PCT No.: PCT/IB2009/007259

§ 371 Date: Jul. 25, 2011

Related U.S. Application Data
(60) Provisional application No. 61/108,919, filed on Oct. 28, 2008.

(51) Int. Cl. H04B 1/02; H04B 1/06

(52) U.S. Cl. 375/295; 375/316

(57) ABSTRACT

Disclosed is a method, circuit and system for wireless communication, including communication in an extremely high radio frequency range. There is provided a transmitter, such as an orthogonal frequency-division multiplexing (“OFDM”) based transmitter, which may transmit data in a frequency band residing within the range of 5 GHZ to 300 GHZ using transmission symbols.

### FIELD OF THE INVENTION

Some embodiments relate generally to the field of wireless communication and, more particularly, to a device, method and system of wireless communication over an extremely high radio-frequency band.

### BACKGROUND

Wireless communication has rapidly evolved over the past decades. Even today, when high performance and high bandwidth wireless communication equipment is made available there is demand for even higher performance at a higher data rates, which may be required by more demanding applications.

Video signals may be generated by various video sources, for example, a computer, a game console, a Video Cassette Recorder (VCR), a Digital-Versatile-Disc (DVD), a Blu-ray (BR) disk player, or any other suitable video source, In many houses, for example, video signals are received through cable or satellite links at a Set-Top Box (STB) located at a fixed point.

In many cases, it may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

WHDI—Wireless Home Digital Interface is a standard for wireless high-definition video connectivity between a video source (e.g. cable box) and video sink (e.g. display). It provides a high-quality, uncompressed wireless link which can support delivery of equivalent video data rates of up to 3 Gbit/s (including uncompressed 1080p) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations. Range is beyond 100 feet (30 m), through walls, and latency is less than one millisecond.

The original WHDI design utilizes RF communication signals in the 5 GHz band thus providing a communication channel bandwidth of 20-40 MHz. Since line-of-sight (LOS) isn't required between transmitters and receivers operating in the 5 GHz band, multiple antennas are used in a Multiple-Input-Multiple-Output (MIMO) arrangement, thereby increasing the effective bandwidth and thus improving data transmission speed, signal quality and error protection.

In the present invention, WHDI is designed for RF signals in the extremely high frequency (EHF) (e.g. 60 GHz) band thus providing a communication channel bandwidth of 2 GHz which may be used to increase the data transmission rate, data protection and/or integrity of the data. Since RF signals in the EHF band have a degraded Signal-to-Noise-Ratio (SNR) and/or dynamic range compared to the 5 GHz band, signals must be transmitted using focused beams and LOS is required between transmitters and receivers. For example, a No-Line-Of-Sight (NLOS) communication range over a 60 GHz band may be about 80% shorter than a NLOS communication range over the 5 GHz band. Since beam-forming is used to increase the signal power, a MIMO scheme cannot be employed using multiple antennas operating in the EHF band.

An additional challenge in designing WHDI for the EHF band is the crest factor or peak-to-average ratio (PAR), i.e. the ratio of the instantaneous peak value to the root-mean-square (RMS) average value, of the video data signal. Since edges and/or effects occur spontaneously in video data, a digital representation of the video data may contain many unexpected peaks resulting in a substantially high PAR. The substantially high PAR can detrimental to the ability of a digital-to-analog converter to accurately represent a video data signal in analog form when it is modulated with a carrier frequency in the EHF band.

There is thus a need in the field of wireless communication for improved devices, methods, and systems for transmission in the extremely high radio-frequency band.

### SUMMARY OF THE INVENTION

The present invention is a method, circuit and system for wireless communication, including communication in an extremely high radio frequency range. According to some embodiments of the present invention, there is provided a transmitter, such as an orthogonal frequency-division multiplexing (“OFDM”) based transmitter, which may transmit data in a frequency band residing within the range of 5 GHZ to 300 GHZ using transmission symbols. According to further embodiments of the present invention, the transmission symbols may be comprised of the coefficients of a block of pixels, or a portion thereof, after a de-correlating transformation. The de-correlation transformation may be performed for the purpose of minimizing the energy of the coefficients without compromising the number of degrees of freedom available for transmission. In a communication system having a bandwidth W there are 2W degrees of freedom. If the spectral efficiency ρ is less than 100%, the number of degrees of freedom is 2Wρ per second. According to further embodiments of the present invention, symbols are comprised of multiple bins in the frequency domain, each bin of each symbol comprised of a two dimensional constellation (i.e. a complex number). Since each complex number contains two degrees of freedom the number of complex numbers that can be transmitted is ρW.

According to further embodiments of the present invention, there may be provided a diversity transmission scheme including the transmission of a single data stream using two or more separate complimenting OFDM signal streams comprising different sets frequency bins within the frequency band. The data within the complementing OFDM signal streams may be partially or completely identical. An OFDM based receiver according to the present invention may receive the complimenting streams and separately demodulate the complimenting signal streams into baseband. The receiver may perform baseband diversity reception processing on the resulting two baseband signals.

According to some embodiments of the present invention, a discrete cosine transform (DCT) is performed on a block of pixels of each of the Y, Cr and Cb components of the video. The Y component provides the luminance of the pixel, while the Cr and Cb components provide the color difference information, otherwise known as chrominance. According to some embodiments of the present invention, all the coefficients are transmitted in accordance with the transmission scheme. According to some embodiments of the present invention, only a portion of the coefficients are used for transmission purposes, e.g. avoiding the very high spatial frequency coefficients and transmitting the lower spatial frequency coefficients. According to further embodiments of the present invention, preference is given to DC and near DC coefficients (i.e. coefficients representing low frequencies) over coefficients representing higher frequencies.

According to some embodiments of the present invention, significantly more of the Y related coefficients are preserved for wireless transmission purposes than those for the other two components, as the human eye is more sensitive to luminance then chrominance. According to some embodiments of the present invention, a ratio of at least three coefficients respective of the Y component may be used for each of the Cr and Cb components, e.g. a ratio of 3:1:1, and coefficients respective of luminance receive a preferred treatment over coefficients respective of chrominance. According to further embodiments of the present invention and unlike compression techniques e.g. JPEG and MPEG, the information of the quantization error may be sent over the transmission channel thereby allowing the reconstruction of the video frame and providing an essentially uncompressed transmission of video over a transmission channel.

According to some embodiments of the present invention, the DC coefficients, or near DC coefficients may be represented in a coarse, (i.e. digital) manner. According to further embodiments of the present invention, part of the DC value may be represented as one of a plurality of constellation points of a symbol by performing a quantization on the values and mapping them. According to further embodiments of the present invention, the higher frequency coefficients and the quantization errors of the DC and the near DC components are grouped in pairs, positioning each pair at a point in the complex plane (i.e. as the real and imaginary values of a complex number), thus providing the fine granularity (i.e. analog) values that at an extreme fineness provides for a continuous representation of these values. According to some embodiments of the present invention, a non-linear transformation (i.e. companding) may be performed on the values that comprise the complex numbers, effectively providing better dynamic range and better signal-to-noise ratio in representing the coefficients and quantization errors.

According to some embodiments of the present invention with high available bandwidth, more levels of representation may be introduced in addition to the two-tiered scheme of high and low spatial frequency coefficients. According to further embodiments of the present invention, coefficients may be mapped using a plurality of mapping schemes, by representing some bits in a low mapping technique (e.g. QPSK), some bits with a finer representation (e.g. 16 QAM), some bits with even finer representations (e.g. 64 QAM) and other bits with a shape mapping technique (e.g. as described below).

According to some embodiments of the present invention, a possible mapping allows the mapping of a number of data values to a smaller number of values thereby potentially saving transmission bandwidth (e.g. two numbers are mapped into one number, or three numbers are mapped into two numbers). Although some distortion may be inserted when the original values are reconstructed, the advantage is the capability of also sending the less important data on the available bandwidth.

According to further embodiments of the present invention, the OFDM based transmitter may use a modulation scheme including a modified complex plane mapping technique such that all mappings to the complex plane are bound within a fixed geometry/shape on the plane. According to further embodiments of the present invention, each point on the geometry/shape may have a low radial diversity or derivative relative to each other point on the geometry/shape.

A corresponding OFDM based receiver according to some embodiments of the present invention may demodulate a received signal using an inverse complex plane mapping with a bounding geometry/shape corresponding (e.g. identical) to that used on the transmitter. According to further embodiments of the present invention, demodulation on the receiver may include associating a received signal point on the complex plane with a closest point on the bounding geometry/shape.

According to some embodiments of the present invention, sub-channels of the transmission channel, normally avoided so as to provide necessary margin or to avoid interference problems, may be used for the purpose of transmitting coefficient values which generally receive a lesser representation. By transmitting the less important values over the normally unused sub-channels, the available bandwidth for transmission is effectively increased.

Further details with regard to methods and systems of uncompressed, wireless transmission of video are described in U.S. patent application Ser. No. 11/551,641 which application is hereby incorporated by reference in its entirety.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary video source transceiver and video sink transceiver arrangement, according to some embodiments of the present invention;

FIG. 2A is a functional block diagram of an exemplary OFDM transmitter circuit according to some embodiments of the present invention where the transmitter includes a shape mapping scheme;

FIG. 2B is a functional block diagram of an exemplary OFDM transmitter circuit according to some embodiments of the present invention where the transmitter includes a reception diversity processing scheme;

FIG. 2C is a functional block diagram of an exemplary OFDM transmitter circuit according to some embodiments of the present invention where the transmitter includes a shape mapping scheme and a reception diversity processing scheme;

FIG. 3A is a functional block diagram of an exemplary OFDM receiver circuit according to some embodiments of the present invention where the receiver includes a shape detecting scheme;

FIG. 3B is a functional block diagram of an exemplary OFDM receiver circuit according to some embodiments of the present invention where the receiver includes a reception diversity processing scheme;

FIG. 3C is a functional block diagram of an exemplary OFDM receiver circuit according to some embodiments of the present invention where the receiver includes a shape detecting scheme and a reception diversity processing scheme.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g., from the Internet.

According to some embodiments of the present invention, there may be a transmitter comprising a mapper adapted to map a baseband value onto a point of a fixed shape on a complex plane. According to further embodiments of the present invention, the shape may include at least a portion whose points are at a substantially constant radius from the complex plane origin. According to some embodiments of the present invention, the mapper may be part of an orthogonal frequency-division multiplexing (OFDM) bin. According to further embodiments of the present invention, the transmitter may be an OFDM transmitter having multiple bins. According to further embodiments of the present invention, the transmitter may comprise a data stream splitter adapted to split a data stream to be transmitted into a set of OFDM bins such that at least two bins are carrying complementing data suitable for reception diversity processing.

According to some embodiments of the present invention, there may be transmission method comprising mapping a baseband value into a point of a fixed shape on a complex plane. According to further embodiments of the present invention, the shape may include at least a portion whose points are at a substantially constant radius form the complex plane origin. According to some embodiments of the present invention, the data may be transmitted on an orthogonal frequency bin. According to further embodiments of the present invention, the data may be split across a set of OFDM bins such that at least two bins are carrying complementing data suitable for reception diversity processing.

According to some embodiments of the present invention, there may be a receiver comprising a shape based symbol detector adapted to determine a symbol value by correlating a received signal to a point on a fixed shape within a complex plane. According to further embodiments of the present invention, at least a portion of the shape may include points that are at a substantially constant radius from the complex plane origin. According to further embodiments of the present invention, correlating may include identifying a point on the shape closest to the received signal value. According to some embodiments of the present invention, the receiver further comprise a diversity reception processing circuit adapted to perform diversity reception processing on data received from two or more bins of an orthogonal frequency-division multiplexing transmission.

According to some embodiments of the present invention, there may be a method of receiving comprising determining a symbol value by correlating a received signal to a point on a fixed shape within a complex plane. According to further embodiments of the present invention, at least a portion of the shape may include points that are at a substantially constant radius from the complex plane origin. According to further embodiments of the present invention, correlating include identifying a point on the shape closest to the received signal value. According to some embodiments of the present invention, the method may further comprise a diversity reception processing on data received from two or more bins of an orthogonal frequency-division multiplexing transmission.

According to some embodiments of the present invention, there may be a transmitter comprising a data stream splitter adapted to split a data stream to be transmitted into a set of orthogonal frequency-division multiplexing (OFDM) bins such that at least two bins are carrying complementing data suitable for reception diversity processing. According to further embodiments of the present invention, the transmitter further comprises a mapper adapted to map a baseband value onto a point of a fixed shape on a complex plane.

According to some embodiments of the present invention, there is a transmission method comprising splitting a data stream to be transmitted into a set of OFDM bins such that at least two bins are carrying complementing data suitable for reception diversity processing. According to further embodiments of the present invention, the method further comprises mapping a baseband value onto a point of a fixed shape on a complex plane.

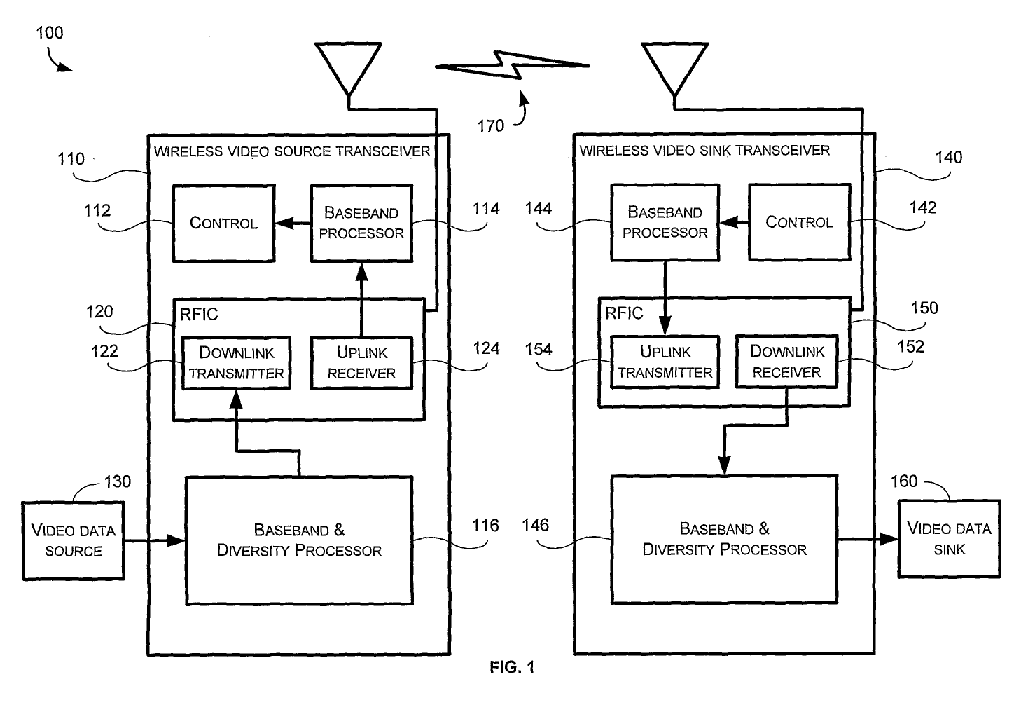

Turning now to FIG. 1, there is shown a functional block diagram of an exemplary video source transceiver and video sink transceiver arrangement (100), according to some embodiments of the present invention.

According to some embodiments of the present invention, a wireless video source transceiver (110) may include a radio-frequency integrated chip (RFIC) (120) to transmit and receive data signals along a functionally associated antenna. According to further embodiments of the present invention, the RFIC may include a downlink transmitter (122) for transmitting downlink data signals and an uplink receiver (124) for receiving uplink data signals.

According to some embodiments of the present invention, the wireless video source transceiver (110) may include a baseband processor (114) to process control signals received via the uplink receiver (124) and send the data to a functionally associated control circuit and/or processor (112). According to some embodiments of the present invention, the wireless video source transceiver (110) may include a baseband and diversity processor (116) to take incoming video data signals from a functionally associated video data source (130) and process the data for downlink transmission, via the downlink transmitter (122), to a functionally associated wireless video sink transceiver (140).

According to some embodiments of the present invention, a wireless video sink transceiver (140) may include a RFIC chip (150) to transmit and receive data signals along a functionally associated antenna. According to further embodiments of the present invention, the RFIC include a downlink receiver (152) for receiving downlink data signals and an uplink transmitter (154) for transmitting uplink data signals.

According to some embodiments of the present invention, the wireless video sink transceiver (140) may include a baseband processor (144) to process control data received from a functionally associated control circuit and/or processor (142) and send the control data to the uplink transmitter (154). According to some embodiments of the present invention, the wireless video sink transceiver (140) may include a baseband and diversity processor (146) to take video data signals received, via the downlink receiver (152), from a functionally associated wireless video source transceiver (110) and process the data for a functionally associated video data sink (160).

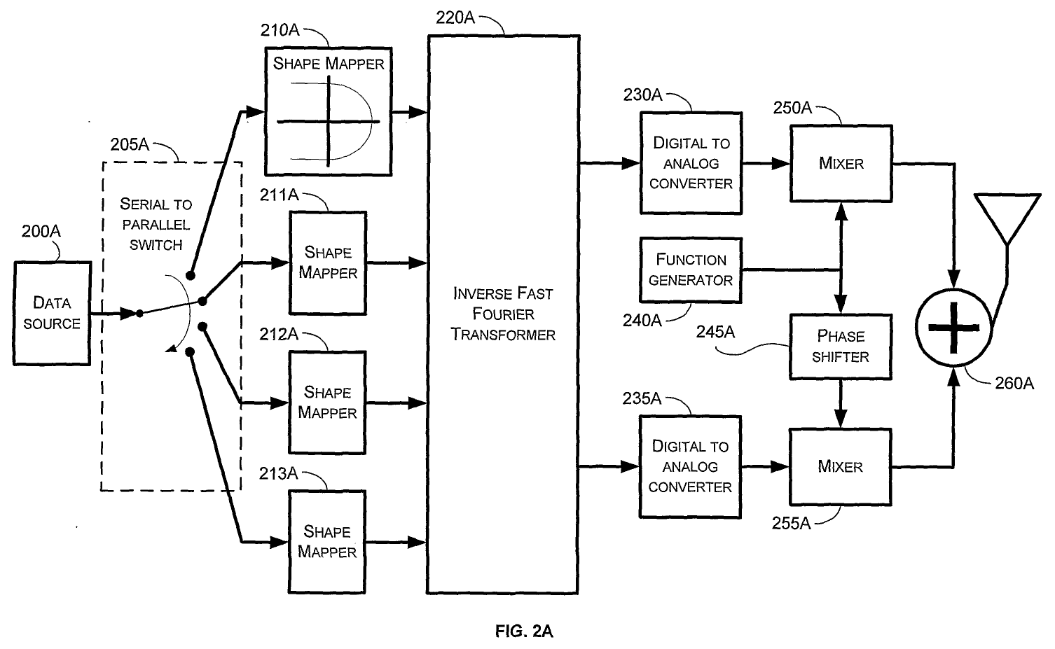

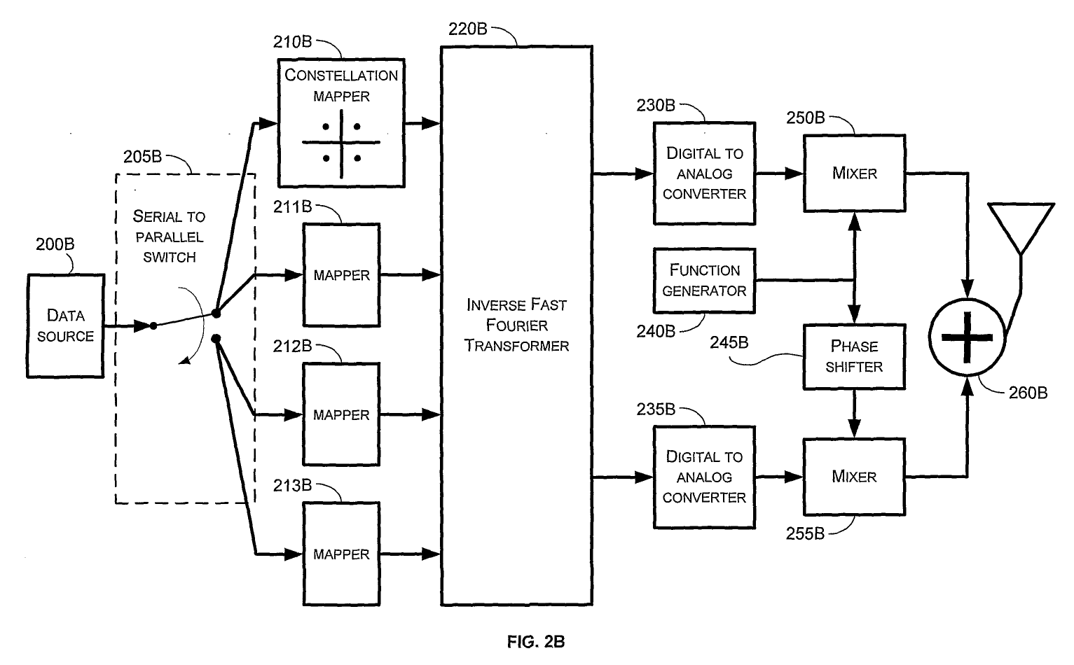

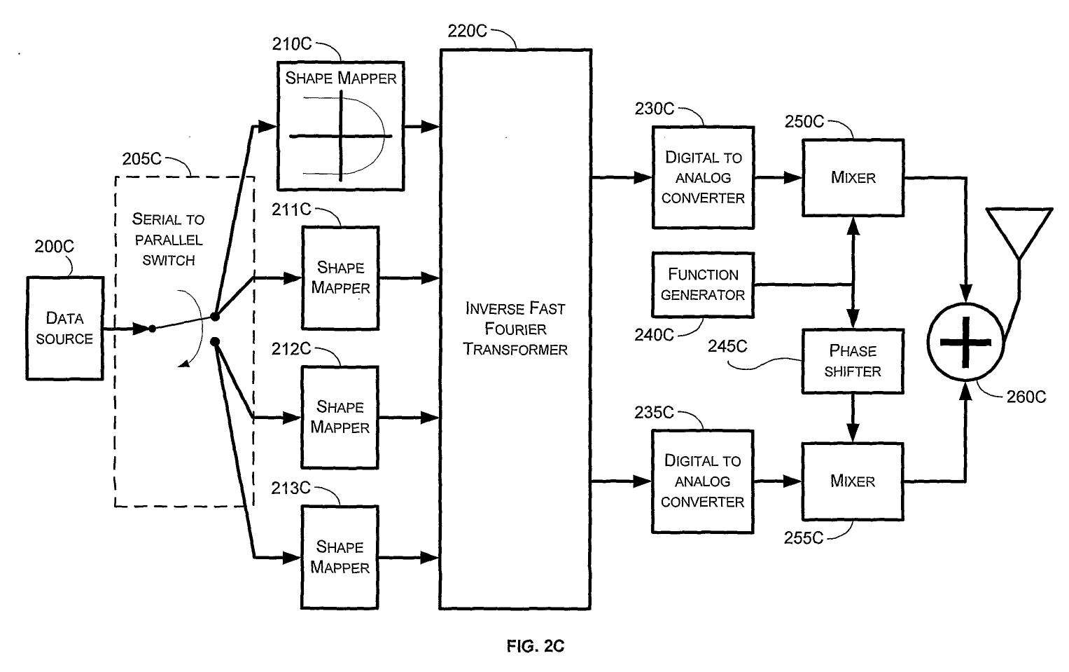

Turning now to FIG. 2A, there is shown a functional block diagram of an exemplary OFDM transmitter circuit according to some embodiments of the present invention where the transmitter includes a shape mapping scheme.

According to some embodiments of the present invention, there may be included a serial to parallel switch (205A) to take digital data serially from a functionally associated data source (200A) and to load the data into a plurality of functionally associated shape mappers (210A-213A). According to some embodiments of the present invention, shape mappers may employ a modified complex plane mapping technique such that all mappings to the complex plane are bound within a fixed geometry/shape on the plane. According to further embodiments of the present invention, a data value may be output from each shape mapper and input as a frequency component, or bin, to a functionally associated Inverse Fast Fourier Transformer (IFFT) (220A).

According to further embodiments of the present invention, the IFFT (200A) may compute an inverse discrete Fourier transform on the input shape data and output a set of complex time-domain digital samples. According to further embodiments of the present invention, the real portions of the complex time-domain digital samples may be converted into an analog signal by a functionally associated digital-to-analog converter (230A). According to further embodiments of the present invention, the imaginary portions of the complex time-domain digital samples may be converted into an analog signal by a functionally associated digital-to-analog converter (235A).

According to further embodiments of the present invention, the analog version of the real portions of the complex time-domain digital samples may be input to a mixer (250A) to modulate a carrier frequency signal output from a function generator (240A). According to further embodiments of the present invention, the analog version of the imaginary portions of the complex time-domain digital samples may be input to a mixer (255A) to modulate a carrier frequency signal output from a function generator (240A) and shifted 90 degrees by a phase shifter (245A). According to further embodiments of the present invention, both modulated carrier frequency signals may be summed by an adder (260A) to produce a transmission signal to be sent via a functionally associated antenna.

Turning now to FIG. 2B, there is shown a functional block diagram of an exemplary OFDM transmitter circuit according to some embodiments of the present invention where the transmitter includes a reception diversity processing scheme.

According to some embodiments of the present invention, there may be included a serial to parallel switch (205B) to take digital data serially from a functionally associated data source (200B) and to load the data into a plurality of functionally associated constellation mappers (210B-213B). According to further embodiments of the present invention, redundant and/or complimentary data may be loaded onto neighboring constellation mappers (210B & 211B, 212B & 213B) to enable reception diversity processing by a functionally associated OFDM receiver circuit. According to some embodiments of the present invention, constellation mappers may employ a known complex plane mapping technique (e.g. QPSK, 16 QAM, 64 QAM, etc.) to map the input data into symbols. According to further embodiments of the present invention, a symbol may be output from each constellation mapper and input as a frequency component, or bin, to a functionally associated Inverse Fast Fourier Transformer (IFFT) (220B).

According to further embodiments of the present invention, the IFFT (200B) may compute an inverse discrete Fourier transform on the input constellation data and output a set of complex time-domain digital samples. According to further embodiments of the present invention, the real portions of the complex time-domain digital samples may be converted into an analog signal by a functionally associated digital-to-analog converter (230B). According to further embodiments of the present invention, the imaginary portions of the complex time-domain digital samples may be converted into an analog signal by a functionally associated digital-to-analog converter (235B).

According to further embodiments of the present invention, the analog version of the real portions of the complex time-domain digital samples may be input to a mixer (250B) to modulate a carrier frequency signal output from a function generator (240B). According to further embodiments of the present invention, the analog version of the imaginary portions of the complex time-domain digital samples may be input to a mixer (255B) to modulate a carrier frequency signal output from a function generator (240B) and shifted 90 degrees by a phase shifter (245B). According to further embodiments of the present invention, both modulated carrier frequency signals may be summed by an adder (260B) to produce a transmission signal to be sent via a functionally associated antenna.

Turning now to FIG. 2C, there is shown a functional block diagram of an exemplary OFDM transmitter circuit according to some embodiments of the present invention where the transmitter includes a shape mapping scheme and a reception diversity processing scheme.

According to some embodiments of the present invention, there may be included a serial to parallel switch (205C) to take digital data serially from a functionally associated data source (200C) and to load the data into a plurality of functionally associated shape mappers (210C-213C). According to further embodiments of the present invention, redundant and/or complimentary data may be loaded onto neighboring shape mappers (210C & 211C, 212C & 213C) to enable reception diversity processing by a functionally associated OFDM receiver circuit. According to some embodiments of the present invention, shape mappers may employ a modified complex plane mapping technique such that all mappings to the complex plane are bound within a fixed geometry/shape on the plane. According to further embodiments of the present invention, a data value may be output from each shape mapper and input as a frequency component, or bin, to a functionally associated Inverse Fast Fourier Transformer (IFFT) (220C).

According to further embodiments of the present invention, the IFFT (200C) may compute an inverse discrete Fourier transform on the input shape data and output a set of complex time-domain digital samples. According to further embodiments of the present invention, the real portions of the complex time-domain digital samples may be converted into an analog signal by a functionally associated digital-to-analog converter (230C). According to further embodiments of the present invention, the imaginary portions of the complex time-domain digital samples may be converted into an analog signal by a functionally associated digital-to-analog converter (235C).

According to further embodiments of the present invention, the analog version of the real portions of the complex time-domain digital samples may be input to a mixer (250C) to modulate a carrier frequency signal output from a function generator (240C). According to further embodiments of the present invention, the analog version of the imaginary portions of the complex time-domain digital samples may be input to a mixer (255C) to modulate a carrier frequency signal output from a function generator (240C) and shifted 90 degrees by a phase shifter (245C). According to further embodiments of the present invention, both modulated carrier frequency signals may be summed by an adder (260C) to produce a transmission signal to be sent via a functionally associated antenna.

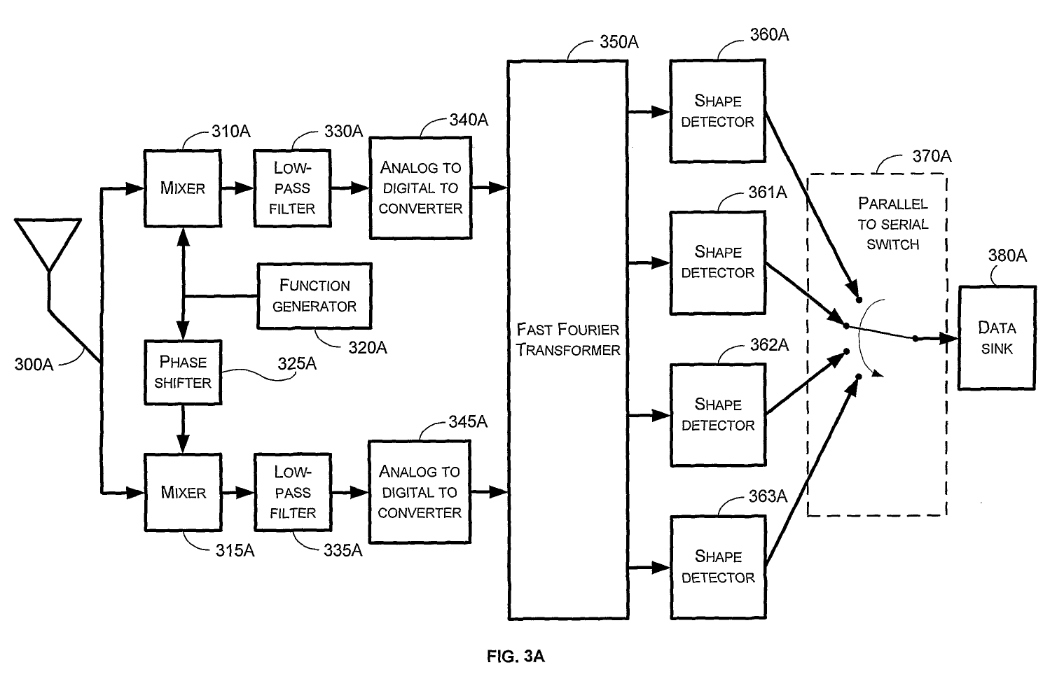

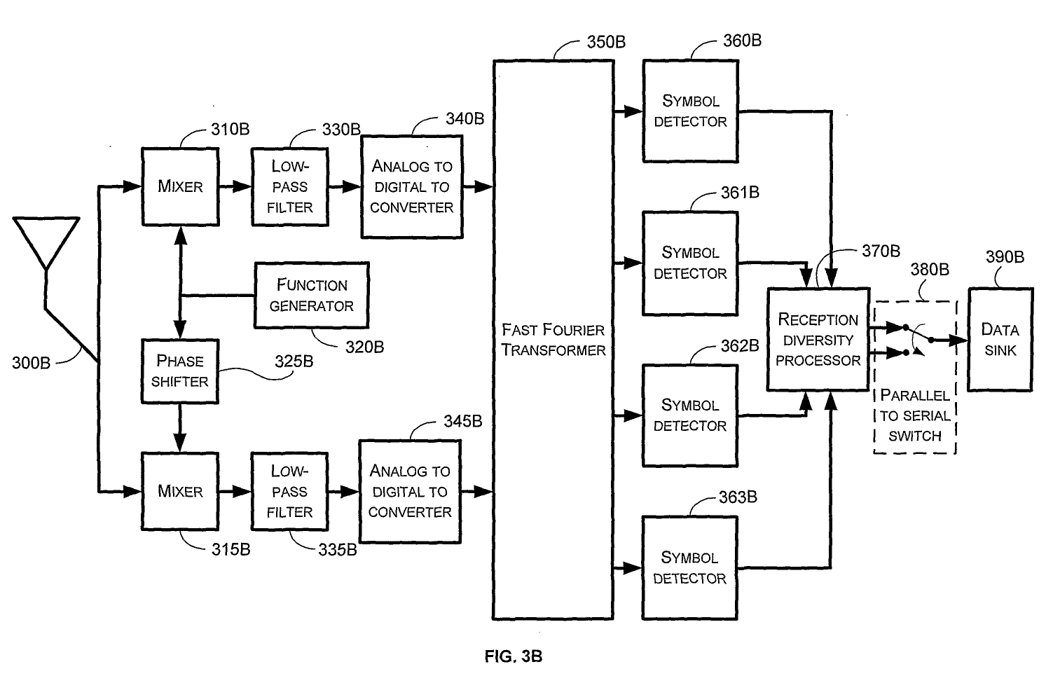

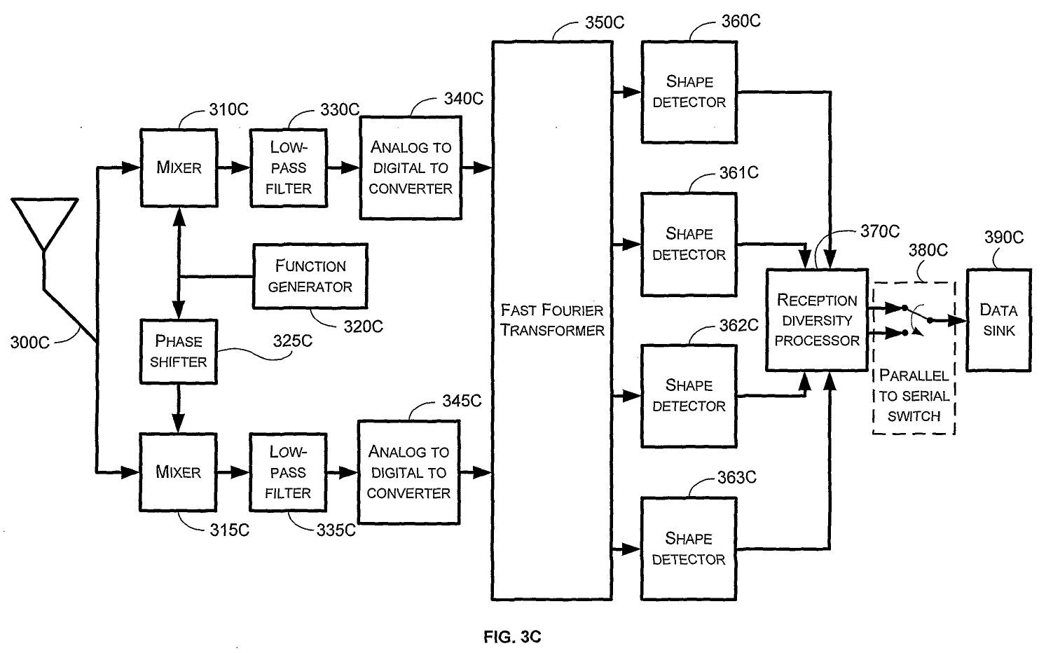

Turning now to FIG. 3A, there is shown a functional block diagram of an exemplary OFDM receiver circuit according to some embodiments of the present invention where the receiver includes a shape detecting scheme.

According to some embodiments of the present invention, there may be included an antenna (300A) to receive a transmission signal produced by a functionally associated OFDM transmitter circuit. According to further embodiments of the present invention, the signal may be quadrature-mixed, by a mixer (310A), with a carrier frequency signal output from a function generator (320A) to produce a baseband version of the transmission signal. According to further embodiments of the present invention, the signal may be filtered by a low-pass filter (330A) to remove undesirable components from the baseband signal. According to further embodiments of the present invention, the baseband signal may be converted to digital form by an analog-to-digital converter (340A). According to further embodiments of the present invention, the digital values may be input to the Fast Fourier Transformer (FFT) (350A) as the real portions of the complex time-domain digital samples.

According to further embodiments of the present invention, the transmission signal may be quadrature-mixed, by a mixer (315A), with a carrier frequency signal output from a function generator (320A) and shifted 90 degrees by a phase shifter (325A) to produce another baseband version of the transmission signal. According to further embodiments of the present invention, the signal may be filtered by a low-pass filter (335A) to remove undesirable components from the baseband signal. According to further embodiments of the present invention, the baseband signal may be converted to digital form by an analog-to-digital converter (345A). According to further embodiments of the present invention, the digital values may be input to the FFT (350A) as the imaginary portions of the complex time-domain digital samples.

According to further embodiments of the present invention, the FFT (350A) may perform a discrete Fourier transform on the real portions of the complex time-domain digital samples and the imaginary portions of the complex time-domain digital samples. According to further embodiments of the present invention, the FFT (350A) may output several parallel frequency components which are input to shape detectors (360A-363A). According to further embodiments of the present invention, the shape detectors (360A-363A) may output digital values representing the original digital data produced by a functionally associated data source (200A). According to further embodiments of the present invention, the digital values may be sampled by a parallel to serial switch (370A) and delivered serially to a functionally associated data sink (380A).

Turning now to FIG. 3B, there is shown a functional block diagram of an exemplary OFDM receiver circuit according to some embodiments of the present invention where the receiver includes a reception diversity processing scheme.

According to some embodiments of the present invention, there may be included an antenna (300B) to receive a transmission signal produced by a functionally associated OFDM transmitter circuit. According to further embodiments of the present invention, the signal may be quadrature-mixed, by a mixer (310B), with a carrier frequency signal output from a function generator (32013) to produce a baseband version of the transmission signal. According to further embodiments of the present invention, the signal may be filtered by a low-pass filter (330B) to remove undesirable components from the baseband signal. According to further embodiments of the present invention, the baseband signal may be converted to digital form by an analog-to-digital converter (340B). According to further embodiments of the present invention, the digital values may be input to the Fast Fourier Transformer (FFT) (350B) as the real portions of the complex time-domain digital samples.

According to further embodiments of the present invention, the transmission signal may be quadrature-mixed, by a mixer (315B), with a carrier frequency signal output from a function generator (320B) and shifted 90 degrees by a phase shifter (325B) to produce another baseband version of the transmission signal. According to further embodiments of the present invention, the signal may be filtered by a low-pass filter (335B) to remove undesirable components from the baseband signal. According to further embodiments of the present invention, the baseband signal may be converted to digital form by an analog-to-digital converter (345B). According to further embodiments of the present invention, the digital values may be input to the FFT (350B) as the imaginary portions of the complex time-domain digital samples.

According to further embodiments of the present invention, the FFT (350B) may perform a discrete Fourier transform on the real portions of the complex time-domain digital samples and the imaginary portions of the complex time-domain digital samples. According to further embodiments of the present invention, the FFT (350B) may output several parallel frequency components which are input to symbol detectors (360B-363B). According to further embodiments of the present invention, the symbol detectors (360B-363B) may output digital values representing the original digital data produced by a functionally associated data source (200B). According to further embodiments of the present invention, the digital values of neighboring symbol detectors (360B & 361B, 362B & 363B) may be input into a reception diversity processor (370B) for reception diversity processing. According to further embodiments of the present invention, the processed digital values may be sampled by a parallel to serial switch (380B) and delivered serially to a functionally associated data sink (390B).

Turning now to FIG. 3C, there is shown a functional block diagram of an exemplary OFDM receiver circuit according to some embodiments of the present invention where the receiver includes a shape detecting scheme and a reception diversity processing scheme.

According to some embodiments of the present invention, there may be included an antenna (300C) to receive a transmission signal produced by a functionally associated OFDM transmitter circuit. According to further embodiments of the present invention, the signal may be quadrature-mixed, by a mixer (310C), with a carrier frequency signal output from a function generator (320C) to produce a baseband version of the transmission signal. According to further embodiments of the present invention, the signal may be filtered by a low-pass filter (330C) to remove undesirable components from the baseband signal. According to further embodiments of the present invention, the baseband signal may be converted to digital form by an analog-to-digital converter (340C). According to further embodiments- of the present invention, the digital values may be input to the Fast Fourier Transformer (FFT) (350C) as the real portions of the complex time-domain digital samples.

According to further embodiments of the present invention, the transmission signal may be quadrature-mixed, by a mixer (315C), with a carrier frequency signal output from a function generator (320C) and shifted 90 degrees by a phase shifter (325C) to produce another baseband version of the transmission signal. According to further embodiments of the present invention, the signal may be filtered by a low-pass filter (335C) to remove undesirable components from the baseband signal. According to further embodiments of the present invention, the baseband signal may be converted to digital form by an analog-to-digital converter (345C). According to further embodiments of the present invention, the digital values may be input to the FFT (350C) as the imaginary portions of the complex time-domain digital samples.

According to further embodiments of the present invention, the FFT (350C) may perform a discrete Fourier transform on the real portions of the complex time-domain digital samples and the imaginary portions of the complex time-domain digital samples. According to further embodiments of the present invention, the FFT (350C) may output several parallel frequency components which are input to shape detectors (360C-363C). According to further embodiments of the present invention, the shape detectors (360C-363C) may output digital values representing the original digital data produced by a functionally associated data source (200C). According to further embodiments of the present invention, the digital values of neighboring shape detectors (360C & 361C, 362C & 363C) may be input into a reception diversity processor (370C) for reception diversity processing. According to further embodiments of the present invention, the processed digital values may be sampled by a parallel to serial switch (380C) and delivered serially to a functionally associated data sink (390C).

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A transmitter comprising:
a mapper adapted to map a baseband value onto a point of a fixed shape on a complex plane.

2. The transmitter according to claim 1, wherein the shape includes at least a portion whose points are at a substantially constant radius from the complex plane origin.

3. The transmitter according to claim 2, wherein said mapper is part of an orthogonal frequency-division multiplexing (OFDM) bin.

4. The transmitter according to claim 3, wherein said transmitter is a OFDM transmitter having multiple bins, and said transmitter further comprises a data stream splitter adapted to split a data stream to be transmitted into a set of orthogonal frequency-division multiplexing (OFDM) bins such that at least two bins are carrying complementing data suitable for reception diversity processing.

5. A transmission method comprising:
mapping a baseband value onto a point of a fixed shape on a complex plane.

6. The method according to claim 5, wherein the shape includes at least a portion whose points are at a substantially constant radius from the complex plane origin.

7. The method according to claim 6, further comprising transmitting the data on an orthogonal frequency-division multiplexing (OFDM) bin.

8. The method according to claim 7, further comprising splitting the data across a set of orthogonal frequency-division multiplexing (OFDM) bins such that at least two bins are carrying complementing data suitable for reception diversity processing.

9. A receiver comprising:
a shape based symbol detector adapted to determine a symbol value by correlating a received signal to a point on a fixed shape within a complex plane.

10. The receiver according to claim 9, wherein at least a portion of the shape includes points that are at a substantially constant radius from the complex plane origin.

11. The receiver according to claim 10, wherein correlating includes identifying a point on the shape closest to the received signal value.

12. The receiver according to claim 9, further comprising a diversity reception processing circuit adapted to perform diversity reception processing on data received from two or more bins of an orthogonal frequency-division multiplexing transmission.

13. A method of receiving comprising:
determining a symbol value by correlating a received signal to a point on a fixed shape within a complex plane.

14. The method according to claim 13, wherein at least a portion of the shape includes points that are at a substantially constant radius from the complex plane origin.

15. The method according to claim 13, wherein correlating includes identifying a point on the shape closest to the received signal value.

16. The method according to claim 13, further comprising a diversity reception processing on data received from two or more bins of an orthogonal frequency-division multiplexing transmission.

17. A transmitter comprising:
a data stream splitter adapted to split a data stream to be transmitted into a set of orthogonal frequency-division multiplexing (OFDM) bins such that at least two bins are carrying complementing data suitable for reception diversity processing.

18. The transmitter according to claim 17 further comprising a mapper adapted to map a baseband value onto a point of a fixed shape on a complex plane.

19. A transmission method comprising:
splitting a data stream to be transmitted into a set of OFDM bins such that at least two bins are carrying complementing data suitable for reception diversity processing.

20. The method according to claim 19 further comprising mapping a baseband value onto a point of a fixed shape on a complex plane.
